(19) United States
(12) Patent Application Publication
(10) Pub. No.: US 2026/0178100 A1
(43) Pub. Date: Jun. 25, 2026

(54) Compact, power-efficient sensing array

(71) Applicant: Lyte AI, Inc., Mountain View, CA (US)

(72) Inventors: Arman Hajati, San Carlos, CA (US); Andrew J.H. Sutton, Amaroo (AU); Alexander Shpunt, Saratoga, CA (US)

(21) Appl. No.: 19/124,869

(22) PCT Filed: Oct. 20, 2023
(86) PCT No.: PCT/US2023/077383

§ 371 Date: Apr. 27, 2025

Related U.S. Application Data
(60) Provisional application No. 63/426,054, filed on Nov. 17, 2022.

(51) Int. Cl. G06F 1/3203

(52) U.S. Cl. CPC G06F 1/3203

(57) ABSTRACT

An optical sensing system (20) includes an array (32) of optical transceiver cells (34), arranged in multiple banks (A, B, C, D), which transmit respective beams of outgoing optical radiation toward a target scene and to receive and sense incoming optical radiation from the target scene. An optical switching network (38) delivers outgoing optical radiation selectively from a laser (54) to the banks. A controller (48) is configured to activate the system to sense a target scene during a succession of activation periods (70), which are interleaved with sleep periods (72), such that during each activation period the controller turns on the laser and then controls the optical switching network during the activation period to deliver the outgoing optical radiation to the multiple banks in succession for transmission by the optical transducers in each of the banks, and then turns off the laser following the activation period.

### CROSS-REFERENCE TO RELATED APPLICATIONS

This application claims the benefit of U.S. Provisional Patent Application 63/426,054, filed Nov. 17, 2022. This application is also related to PCT Patent Applications PCT/US2022/40526 and PCT/US2022/40527, both filed Aug. 17, 2022. The disclosures of all these related applications are incorporated herein by reference.

### FIELD

The present invention relates generally to systems and methods for optical sensing, and particularly to integrated optical sensing devices.

### BACKGROUND

In many optical sensing applications, multiple points on a target are irradiated by an optical beam or beams, and the reflected radiation from each point is processed to analyze properties of the target. In some applications, such as optical coherence tomography (OCT) and continuous-wave (CW) LiDAR, a coherent beam is transmitted toward the target, and the reflected radiation is sensed and processed coherently with the transmitted radiation. To sense the properties of the target with high resolution, the transmitted beam may be scanned over the target area, or an array of multiple beams may be transmitted and sensed simultaneously using an array of receivers.

The terms “optical,” “light,” and “optical radiation,” as used in the present description and in the claims, refer to electromagnetic radiation in any of the visible, infrared, and ultraviolet spectral ranges.

### SUMMARY

Embodiments of the present invention that are described hereinbelow provide improved systems, devices, and methods for optical sensing.

There is therefore provided, in accordance with an embodiment of the invention, an optical sensing system, including an array of optical transceiver cells, arranged in multiple banks and configured to transmit respective beams of outgoing optical radiation toward a target scene and to receive and sense incoming optical radiation from the target scene. A laser is configured to generate the outgoing optical radiation. An optical switching network is coupled to deliver the outgoing optical radiation selectively from the laser to the banks for transmission by the optical transceiver cells. A controller is configured to activate the system to sense a target scene during a succession of activation periods, which are interleaved with sleep periods, such that during each activation period the controller turns on the laser and then controls the optical switching network during the activation period to deliver the outgoing optical radiation to the multiple banks in succession for transmission by the optical transducers in each of the banks, and then turns off the laser following the activation period.

In some embodiments, a duty cycle of the activation periods relative to the sleep periods is less than 50% or even less than 10%.

In a disclosed embodiment, the optical transceiver cells are configured to measure ranges to respective points in the target scene by coherent sensing of the incoming optical radiation.

In some embodiments, the optical switching network includes a hierarchy of active optical switches, which are set by the controller to select the banks that are to receive the outgoing optical radiation. In one embodiment, the optical transceiver cells in each bank are arranged in multiple columns, and the optical switching network further includes passive splitters, which are coupled to distribute the outgoing optical radiation from the optical switches among the columns in each bank. Additionally or alternatively, the array of the optical transceiver cells and the optical switching network are disposed on a photonic integrated circuit (PIC) and are interconnected by optical waveguides on the PIC.

In some embodiments, the optical transceiver cells have respective fields of view into which the respective beams of outgoing optical radiation are transmitted, and the system includes a scanner, which is configured to scan the fields of view across respective parts of the target scene. In one embodiment, the controller is configured to control the scanner so that in a first sensing mode, the scanner is inactive, whereby the transceiver cells sense a matrix of points in the target scene with a first resolution determined by a pitch of the transceiver cells, and to actuate the scanner in a second sensing mode so as to sense the target scene with a second resolution, finer than the first resolution. Typically, in the first sensing mode, the controller activates the laser only during the activation periods, which are interleaved with the sleep periods, and in the second sensing mode, the controller activates the laser continuously.

There is also provided, in accordance with an embodiment of the invention, an optical sensing system, including an array of optical sensing cells, having respective fields of view. A scanner is configured to scan the fields of view of the optical sensing cells across respective parts of a target scene. A controller is configured to operate the system in a low-power mode of operation in which the optical sensing cells sense a matrix of points in the target scene with a first resolution in a staring configuration, and to switch the system to a high-power mode of operation in which the scanner scans the fields of view of the optical sensing cells to sense the target scene with a second resolution, finer than the first resolution.

In some embodiments, the optical sensing cells include optical transceiver cells, which are configured to transmit respective beams of outgoing optical radiation toward the target scene and receive incoming optical radiation from the target scene. In a disclosed embodiment, the optical transceiver cells are configured to measure ranges to the points in the target scene by coherent sensing of optical radiation reflected from the target scene.

In some embodiments, in the low-power mode, the controller activates the system to sense the target scene during a succession of activation periods, which are interleaved with sleep periods during which the system is inactive. In a disclosed embodiment, the controller activates the system to operate continuously while in the high-power mode.

In some embodiments, the controller is configured to detect a feature of interest in an image captured by the array of optical sensing cells while operating in the low-power mode, and to switch the system to the high-power mode responsively to the detected feature. In one embodiment, the controller is configured to control the array of optical sensing cells and the scanner so as sense, in the high-power mode, a part of the target scene that contains the feature of interest.

In a disclosed embodiment, the scanner is inactive in the low-power mode of operation. Alternatively or additionally, the scanner is configured to shift the fields of view of the sensing cells from frame to frame in the low-power mode of operation.

Further alternatively or additionally, the controller is configured to vary a frame rate and to vary the second resolution of the system in the high-power mode of operation.

There is additionally provided, in accordance with an embodiment of the invention, a method for optical sensing, which includes providing an optical sensing device including an array of optical sensing cells, having respective fields of view. The device is operated in a low-power mode, in which the sensing cells sense a matrix of points in a target scene with a first resolution in a staring configuration. The device can be switched to a high-power mode in which a scanner scans the fields of view of the optical sensing cells to sense the target scene with a second resolution, finer than the first resolution.

The present invention will be more fully understood from the following detailed description of the embodiments thereof, taken together with the drawings in which:

### BRIEF DESCRIPTION OF THE DRAWINGS

FIG. 1A is a block diagram that schematically illustrates an optical sensing system, in accordance with an embodiment of the invention;

FIG. 1B is a schematic pictorial view of the optical sensing system of FIG. 1A;

FIG. 2 is a block diagram that schematically shows details of an optical sensing device, in accordance with an embodiment of the invention;

FIG. 3 is a schematic frontal view of a sensing pattern created by the optical sensing device of FIG. 2 in a low-power mode, in accordance with an embodiment of the invention;

FIG. 4 is a timing diagram that schematically illustrates a pattern of operation of the optical sensing device of FIG. 2 in a low-power mode, in accordance with an embodiment of the invention; and

FIG. 5 is a flow chart that schematically illustrates a method for optical sensing, in accordance with an embodiment of the invention.

### DETAILED DESCRIPTION

As noted earlier, in some coherent sensing applications, multiple beams of optical radiation are directed simultaneously toward a target scene, and an array of receivers senses the optical radiation reflected from the target scene. The sensing resolution is limited by the pitches of the transmitter and receiver arrays, which are, in turn, limited by the sizes of the transmitters and receivers themselves. The resolution may be enhanced by scanning the fields of view of the receivers over small angular ranges, for example as described in the above-referenced PCT patent applications, but at the expense of reduced frame rate (due to the increased length of time required to scan the entire scene).

Some embodiments of the present invention address these problems by providing arrays of sensing cells and scanning systems having low-and high-power modes. The low-power mode can be used to sense a matrix of points in a target scene with low resolution in a staring mode, at a high frame rate. In response to a trigger condition, the system switches to the high-power mode, operating at a lower frame rate and higher resolution. In the high-power mode, the fields of view of the sensing cells in the array are scanned over small angles to cover the target scene with resolution that is finer than the physical pitch of the array of sensing cells (i.e., finer than the projection of the pitch onto the scene by the imaging optics). The trigger condition may be based on detection of an object or event of interest by analyzing the frames that are captured in the low-power mode, for example. Alternatively or additionally, the trigger condition may be invoked by another command or event.

The scan speed, resolution and frame rate of the high-power mode may be fixed or, alternatively, these parameters may be variable to permit the user or system controller to select the optimal tradeoff between resolution, frame rate, and power consumption in each sensing scenario and application.

In some embodiments, while the sensing array operates in the low-power mode, the fields of view of the sensing cells are shifted by a small increment from frame to frame. For example, the same scanner that is used to scan the fields of view within each frame in the high-power mode can be used to shift the fields of view from frame to frame in the low-power mode. Alternatively or additionally, when the sensing array is mounted on a moving platform, the movement of the platform will inherently cause the fields of view of the sensing cells to shift. Thus, a high-resolution image will be built up gradually even in low-power mode, and objects and events of interest can be detected with higher precision.

The present embodiments use arrays of photonic sensing cells. In some embodiments, the arrays comprise transceiver cells, wherein each cell includes optical and optoelectronic components both for transmitting a beam of radiation and for receiving and detecting reflected radiation, along with ancillary electronics. In other embodiments, the cells may comprise components only for receiving and detection of radiation.

In the embodiments that are described below, the beams that are to be transmitted and/or mixed with the reflected radiation for coherent detection are generated and modulated centrally, by a core transceiver engine, and are then distributed among the transceiver cells. An optical switch network time-multiplexes the beams among different groups of cells. This approach is useful in reducing the size, power and complexity requirements of the transceiver cells and the array as a whole. In high-power mode, a scanner scans the fields of view of all the cells over respective parts of the target scene, with resolution finer than the physical pitch of the array of transceiver cells, as noted above. Any suitable scanning mechanism can be used for this purpose, such as an optomechanical scanning device or a tunable laser source with a grating disposed between the projection lens and the target scene.

In some embodiments, the system operates in the low-power mode at a low duty cycle, less than 50% and possible less than 10%. In other words, the optical transceiver cells actively sense the target scene during short activation intervals, interleaved with longer sleep periods, thus reducing the power consumption of the system. This power reduction scheme is particularly useful in conjunction when the system switches between low-and high-power modes of operation, as described above. Alternatively, the scheme can be used in reducing power consumption even in the absence of a high-power scanning mode.

Thus, in these embodiments, the optical transceiver cells in an array are arranged in multiple banks. An optical switching network delivers outgoing optical radiation selectively from a laser to the banks for transmission by the optical transceiver cells. A controller activates the system to sense a target scene during a succession of activation periods, which are interleaved with sleep periods. During each activation period the controller turns on the laser and then controls the optical switching network during the activation period to deliver the outgoing optical radiation to the multiple banks in succession for transmission by the optical transducers in each of the banks. Following the activation period, the controller then turns off the laser to save power.

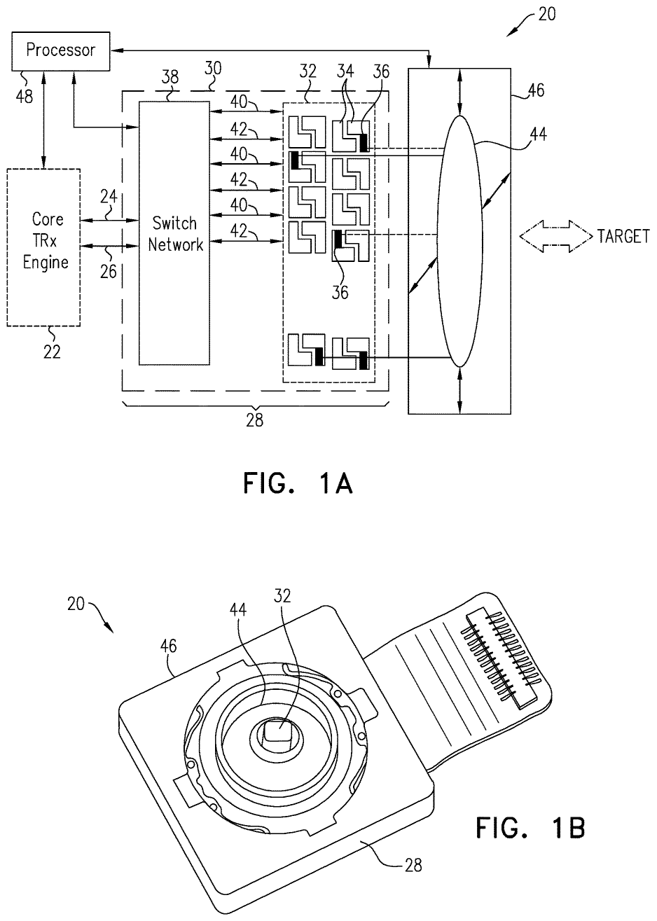

FIGS. 1A and 1B schematically illustrate an optical sensing system 20, in accordance with an embodiment of the invention. FIG. 1A is a block diagram, while FIG. 1B shows a pictorial view.

In system 20, a core transceiver (TRx) engine 22 comprises one or more laser light sources, along with photonic and electronic circuit components for control, modulation, and distribution of the coherent radiation generated by the light sources. TRx engine 22 can implement a variety of different modulation schemes, for example by control of the drive current supplied to the laser or lasers or by modulation of the light output by the laser or lasers. TRx engine 22 is connected by one or more optical waveguides 24, and possibly also an electrical bus 26, to an optoelectronic sensing device 28, which is formed on a substrate 30.

In some embodiments, device 28 is fabricated using photonic integrated circuit (PIC) technology, and substrate 30 comprises a silicon die, for example in a silicon on insulator (SOI) configuration. Alternatively, substrate 30 may comprise other sorts of semiconductor or dielectric materials. Core TRx engine 22 may be disposed on substrate 30, as well, in which case waveguides 24 and bus 26 may conveniently be formed on substrate 30, for example by photolithographic processes. Alternatively, core TRx engine 22 may be coupled to substrate 30 via one or more edge couplers or one or more grating couplers (not shown). Further alternatively, waveguides 24 and bus 26 may comprise optical fibers and conductive wires, respectively.

Device 28 comprises an array 32 of transceiver cells 34 formed on substrate 30. Each transceiver cell 34 comprises an optical transducer 36, which couples light in and out of the cell, along with photonic and electronic components, as described in detail in the above-mentioned PCT patent applications, for example. Transceiver cells 34 comprise photonic components for both transmission and reception of light, so that transducers 36 both transmit light toward a target and receive light reflected from the target. Optical transducers 36 may comprise grating couplers, for example, for surface-coupled configurations of device 28, or edge couplers for edge-coupled configurations.

Transceiver cells 34 have respective fields of view, which are defined by the respective optical apertures of optical transducers 36 and by focusing optics 44, which project the optical apertures onto a target scene. A scanner 46 scans the fields of view over the target. Each transducer 36 emits (and receives) a cone of light that is collimated by optics 44, and the resulting beam from each transducer is projected into a different angle in the field of view. In addition, scanner 46 can scan the beams to control the density of coverage of the field of view of system 20, including varying the density of coverage in different areas of the field. In this manner, even when the fields of view of transducers 36 themselves cover the target only sparsely, the density of coverage can be filled in as desired over the entire target scene or over areas of interest within the target scene.

In the pictured embodiments, scanner 46 comprises an electromechanical motion assembly, which shifts optics 44 by small increments in directions transverse to the optical axis, for example by means of electromagnetic or piezoelectric actuators. Motion assemblies of this sort with two-dimensional shift capabilities are used in cameras for the purpose of optical image stabilization (OIS) and can be adapted for use in system 20. Alternatively or additionally, the motion assembly can be configured to shift sensing device 28 relative to optics 44. Further additionally or alternatively, other sorts of scanners may be used in system 20, such as one or more rotating mirrors, or any other suitable type of mechanical, optical, or wavelength-based scanner that is known in the art.

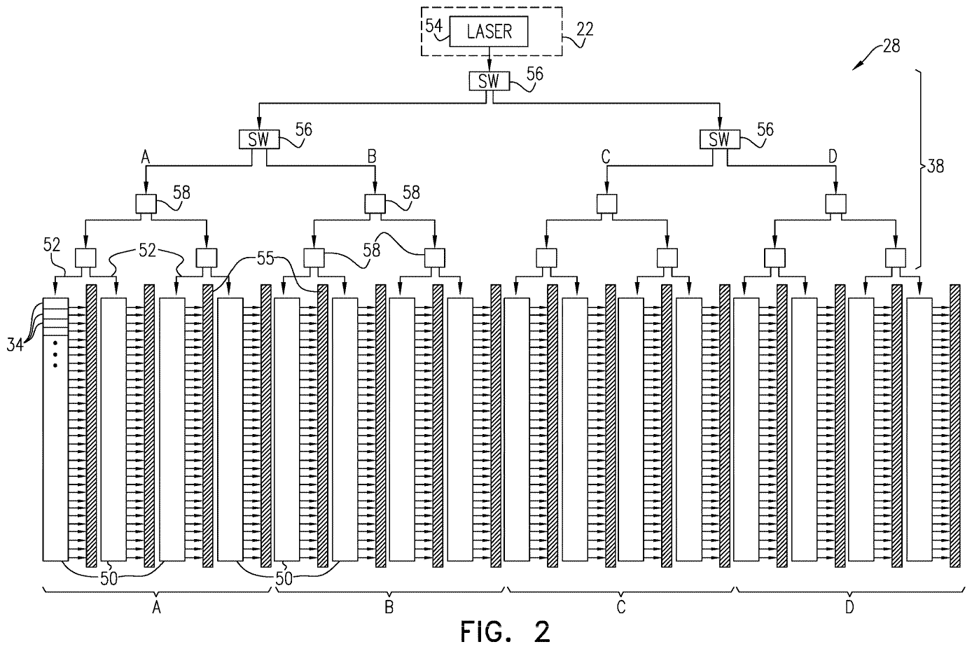

A switch network 38 on substrate 30 distributes light received through waveguides 24 among multiple optical buses 40, which comprise waveguides coupled to deliver the light to different, respective sets of transceiver cells 34. Switch network 38 may also couple electrical signals between electrical bus 26 and electrical buses 42, for transfer of the electrical signals to and from transceiver cells 34. In the embodiment that is described below with reference to FIG. 2, switch network 38 comprises an optical distribution tree, including an active optical network, comprising optoelectronic components which select the buses 40 to which the light is to be distributed, followed by a passive optical splitter array. Alternatively, other sorts of optical distribution networks may be used to distribute the light output by core transceiver engine 22 among transceiver cells 34.

A processor 48 controls the operation of system 20 and receives signals output by transceiver cells 34 in response to light received by device 28. Processor 48 typically comprises a general-purpose microprocessor, with suitable analog and digital interfaces for controlling and receiving signals from the components of system 20. Alternatively or additionally, processor 48 may comprise special-purpose digital logic and other hardware components, which may be hard-wired or programmable. Processor 48 processes the signals output by transceiver cells 34 in order to measure the ranges and/or velocities of points in a target scene relative to system 20, for example, using techniques of coherent LIDAR. These measurements may be used, inter alia, in applications of simultaneous localization and mapping (SLAM).

In one embodiment, processor 48 switches system 20 between low-power and high-power modes of operation. In the low-power mode, scanner 46 is fixed in place, so that each transducer cell 34 interrogates a single, respective point in the target scene. In this mode, the sensing resolution is typically limited by the pitch of optical transducers 36 in array 32. In the high-power mode, processor 48 actuates scanner 46 to shift the fields of view of optical transducers transversely, typically in two dimensions, to interrogate the target scene with a finer pitch. These modes of operation are described further hereinbelow.

In an alternative embodiment, scanner 46 can be omitted from system 20. In this case, array 32 operates only in a staring mode. This system configuration has advantages of smaller size and lower power consumption, though at the cost of reduced resolution.

FIG. 2 is a block diagram that schematically shows details of sensing device 28, in accordance with an embodiment of the invention. In this embodiment, transceiver cells 34 are arranged in an array of sixteen columns 50, with thirty-two cells in each column. Each column is served by a respective bus 52, which supplies a coherent beam from a laser 54 in core transceiver engine 22 to all the cells in the column. In the pictured embodiment, transceiver cells 34 are edge-coupled and therefore direct respective beams of outgoing optical radiation toward turning mirrors 55, which direct the beams toward a target, as well as directing incoming optical radiation from the target back to the transceiver cells. Alternatively, as noted above, the transceiver cells may be surface-coupled.

The laser beam is distributed among columns 50 by switching network 38, which in this embodiment includes a hierarchy of three active switches (SW) 56, for example thermo-optic switches, followed by two tiers of passive splitters 58. The settings of active switches 56 define four banks of transceiver cells 34, marked A, B, C and D, with four columns in each bank. When a given bank is selected, passive splitters 58 in the lower tiers of network 38 distribute the beam among the four columns 50 in the bank. Multiplexing the laser beam among the banks of transceiver cells in this manner is useful in reducing the number of laser devices required for sensing at a given range, as well as reducing the number of signal processing channels required.

The specific arrangement of active switches 56 and passive splitters 58 in switching network 38, as well as the number of light sources, depends on specific application requirements and tradeoffs and is determined by the link budget and the number of signal processing channels available in the system, inter alia. In addition, active switches 56 consume electrical power and are optically more lossy than passive splitters. Reducing the number of switches increases the required number of passive splitters and the number of signal processing channels simultaneously required to process the signals. Using this and other tradeoffs, one can design a variety of systems with differing optimization goals, such as lower power consumption vs. a smaller number of signal processing channels as one example.

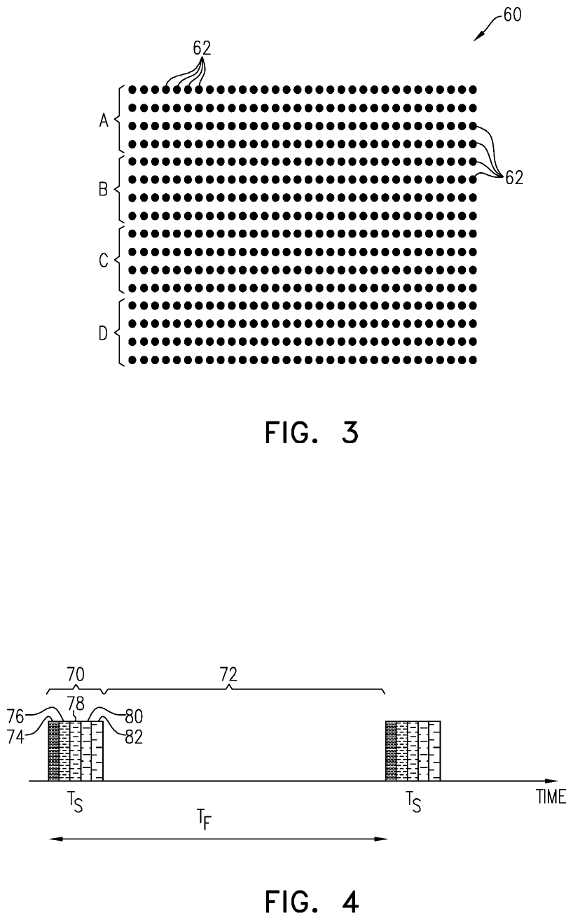

FIG. 3 is a schematic frontal view of a sensing pattern 60 created by sensing device 28 in low-power mode, in accordance with an embodiment of the invention. Each frame captured by device 28 contains 512 pixels, corresponding to respective fields of view 62 of transceiver cells 34 in all four banks A, B, C and D without scanning.

FIG. 4 is a timing diagram that schematically illustrates the pattern of operation of sensing device 28 in low-power mode, in accordance with an embodiment of the invention. To capture a frame with sensing pattern 60 as illustrated in FIG. 3, sensing device 28 is activated for a short activation period 70 of duration T_{S}, within each frame period of duration T_{F}. Activation period 70 within each frame is followed by a long sleep period 72. The duty cycle of the activation periods, relative to the sleep periods, is typically less than 50% of the frame periods and may be only 10% or less. For example, T_{S} may be 250 μs, while the frame period T_{F} is 10 ms, assuming a capture rate of 100 frames/sec, giving a duty cycle of 2.5%.

During each activation period 70, laser 54 is first turned on and stabilized for a stabilization period 74 (for example 50 μs). Switching network 38 (FIG. 2) then distributes the laser beam to each of the four banks A-D in succession over respective sensing periods 76, 78, 80, 82 (50 μs each in the present example). Alternatively, sensing device 28 may be operated at higher or lower duty cycles and frame rates, depending on factors such as the target sensing range and sensitivity and other application requirements.

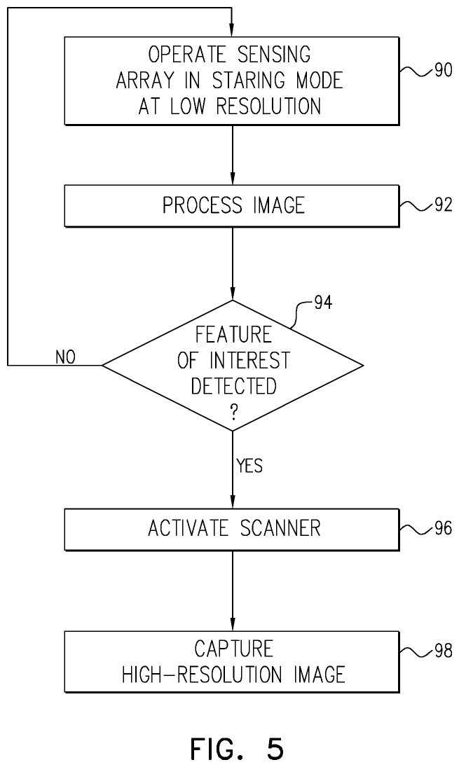

FIG. 5 is a flow chart that schematically illustrates a method for optical sensing with variable resolution, in accordance with an embodiment of the invention. The method is described hereinbelow, for the sake of clarity, with reference to the components of system 20, but it may alternatively be implemented in other systems having a suitable sensing array and scanning capabilities.

Initially, system 20 operates in low-power mode, with sensing device acquiring images at low resolution, in an initial image acquisition step 90. In this step, sensing device 28 operates intermittently in staring mode (during activation periods 70) without scanning, as described above. Processor 48 processes the low-resolution images output by sensing device 28 to extract features of possible interest, at a processing step 92. Processor 48 tests the extracted features to detect any features meeting criteria that would call for high-resolution sampling and analysis, at a feature detection step 94. As long as no features meeting the criteria are detected, sensing device 28 continues to operate in the low-power mode of step 90.

When a feature of interest is detected at step 94, processor 48 switches system 20 to operate in a high-power scanning mode, at a scan activation step 96. In this mode, laser 54 operates continuously, and scanner 46 (FIG. 1) is driven in a raster pattern to shift the fields of view defined by transducers 36 so as to fill in the gaps between the columns and rows of the sensing pattern that is shown in FIG. 3. In this manner, for example, it is possible to capture sensing frames at a resolution of 1 megapixel (960×960 pixels), at a capture rate of approximately 2.5 frames/sec, at a high-resolution acquisition step 98. Alternatively, the frame rate may be increased, at the expense of reduced resolution. The achievable frame rate and resolution depend on factors such as the optical design of system 20, the optical power available from laser 54, and the ranges of distances and angles to be covered.

Additionally or alternatively, when a feature of interest is identified in step 94 in a certain part of the frame while operating device 28 in low-power mode, optical switching network 38 may be controlled to feed the laser beam in high-power mode only to the bank or banks of transceiver cells 34 covering the area containing the feature of interest. Thus, high-resolution images are captured at step 98 in the area of the field of view of system 20 that was found to contain a feature or features of interest.

The specific physical configurations of system 20 and sensing device 28, as well as the operational parameters of the low-and high-power modes of operation, are described above solely by way of example. Other system and array configurations and other sets of operational parameters may alternatively be used for similar purposes and are considered to be within the scope of the present invention.

It will thus be understood that the embodiments described above are cited by way of example, and the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An optical sensing system, comprising:
an array of optical transceiver cells, arranged in multiple banks and configured to transmit respective beams of outgoing optical radiation toward a target scene and to receive and sense incoming optical radiation from the target scene;
a laser configured to generate the outgoing optical radiation;
an optical switching network coupled to deliver the outgoing optical radiation selectively from the laser to the banks for transmission by the optical transceiver cells; and
a controller, which is configured to activate the system to sense a target scene during a succession of activation periods, which are interleaved with sleep periods, such that during each activation period the controller turns on the laser and then controls the optical switching network during the activation period to deliver the outgoing optical radiation to the multiple banks in succession for transmission by the optical transducers in each of the banks, and then turns off the laser following the activation period.

2. The system according to claim 1, wherein a duty cycle of the activation periods relative to the sleep periods is less than 50%.

3. The system according to claim 2, wherein the duty cycle is less than 10%.

4. The system according to claim 1, wherein the optical transceiver cells are configured to measure ranges to respective points in the target scene by coherent sensing of the incoming optical radiation.

5. The system according to claim 1, wherein the optical switching network comprises a hierarchy of active optical switches, which are set by the controller to select the banks that are to receive the outgoing optical radiation.

6. The system according to claim 5, wherein the optical transceiver cells in each bank are arranged in multiple columns, and wherein the optical switching network further comprises passive splitters, which are coupled to distribute the outgoing optical radiation from the optical switches among the columns in each bank.

7. The system according to claim 1, wherein the array of the optical transceiver cells and the optical switching network are disposed on a photonic integrated circuit (PIC) and are interconnected by optical waveguides on the PIC.

8. The system according to claim 1, wherein the optical transceiver cells have respective fields of view into which the respective beams of outgoing optical radiation are transmitted, and wherein the system comprises a scanner, which is configured to scan the fields of view across respective parts of the target scene.

9. The system according to claim 8, wherein the controller is configured to control the scanner so that in a first sensing mode, the scanner is inactive, whereby the transceiver cells sense a matrix of points in the target scene with a first resolution determined by a pitch of the transceiver cells, and to actuate the scanner in a second sensing mode so as to sense the target scene with a second resolution, finer than the first resolution.

10. The system according to claim 9, wherein in the first sensing mode, the controller activates the laser only during the activation periods, which are interleaved with the sleep periods, and wherein in the second sensing mode, the controller activates the laser continuously.

11. An optical sensing system, comprising:
an array of optical sensing cells, having respective fields of view;
a scanner, which is configured to scan the fields of view of the optical sensing cells across respective parts of a target scene; and
a controller, which is configured to operate the system in a low-power mode of operation in which the optical sensing cells sense a matrix of points in the target scene with a first resolution in a staring configuration, and to switch the system to a high-power mode of operation in which the scanner scans the fields of view of the optical sensing cells to sense the target scene with a second resolution, finer than the first resolution.

12. The system according to claim 11, wherein the optical sensing cells comprise optical transceiver cells, which are configured to transmit respective beams of outgoing optical radiation toward the target scene and receive incoming optical radiation from the target scene.

13. The system according to claim 12, wherein the optical transceiver cells are configured to measure ranges to the points in the target scene by coherent sensing of optical radiation reflected from the target scene.

14. The system according to claim 11, wherein in the low-power mode, the controller activates the system to sense the target scene during a succession of activation periods, which are interleaved with sleep periods during which the system is inactive.

15. The system according to claim 14, wherein the controller activates the system to operate continuously while in the high-power mode.

16. The system according to claim 11, wherein the controller is configured to detect a feature of interest in an image captured by the array of optical sensing cells while operating in the low-power mode, and to switch the system to the high-power mode responsively to the detected feature.

17. The system according to claim 16, wherein the controller is configured to control the array of optical sensing cells and the scanner so as sense, in the high-power mode, a part of the target scene that contains the feature of interest.

18. The system according to claim 11, wherein the scanner is inactive in the low-power mode of operation.

19. The system according to claim 11, wherein the scanner is configured to shift the fields of view of the sensing cells from frame to frame in the low-power mode of operation.

20. The system according to claim 11, wherein the controller is configured to vary a frame rate and to vary the second resolution of the system in the high-power mode of operation.

21. A method for optical sensing, comprising:
providing an optical sensing device comprising an array of optical sensing cells, having respective fields of view; operating the device in a low-power mode, in which the sensing cells sense a matrix of points in a target scene with a first resolution in a staring configuration; and
switching the device to a high-power mode in which a scanner scans the fields of view of the optical sensing cells to sense the target scene with a second resolution, finer than the first resolution.

22. The method according to claim 21, wherein providing the optical sensing device comprises measuring ranges to the points in the target scene by coherent sensing of optical radiation reflected from the target scene.

23. The method according to claim 21, wherein operating the device in the low-power mode comprises activating the array to sense the target scene during a succession of activation periods, which are interleaved with sleep periods during which the array is inactive.

24. The method according to claim 23, wherein switching the device comprises operating the device continuously while in the high-power mode.

25. The method according to claim 23, wherein a duty cycle of the activation periods relative to the sleep periods is less than 50%.

26. The method according to claim 25, wherein the duty cycle is less than 10%.

27. The method according to claim 21, wherein switching the device comprises detecting a feature of interest in an image captured by the array of optical sensing cells while operating in the low-power mode, and switching the device to the high-power mode responsively to the detected feature.

28. The method according to claim 27, wherein switching the device comprises controlling the device so as sense, in the high-power mode, a part of the target scene that contains the feature of interest.

29. The method according to claim 21, wherein the scanner is inactive in the low-power mode.

30. The method according to claim 21, wherein operating the device in a low-power mode comprises shifting the fields of view of the sensing cells from frame to frame by the scanner in the low-power mode of operation.

31. The method according to claim 21, wherein switching the device to the high-power mode comprises varying a frame rate and varying the second resolution in the high-power mode of operation.
